(19) United States
(12) Patent Application Publication
(10) Pub. No.: US 2025/0368040 A1
(43) Pub. Date: Dec. 4, 2025

(54) ZONAL ARCHITECTURE AUDIO SYSTEM

(71) Applicant: Rivian IP Holdings, LLC, Irvine, CA (US)

(72) Inventors: Jung Wook HONG, Irvine, CA (US); Emily Joan WILSON, Victoria (CA); Ian Eric ESTEN, Woodside, CA (US); Manu RAVINDRA, Irvine, CA (US)

(21) Appl. No.: 19/071,609

(22) Filed: Mar. 5, 2025

Related U.S. Application Data
(60) Provisional application No. 63/652,601, filed on May 28, 2024.

(51) Int. Cl. B60K 35/26; B60R 16/023; G06F 3/16

(52) U.S. Cl. CPC B60K 35/26; B60R 16/023; G06F 3/165

(57) ABSTRACT

A zonal audio system for a vehicle may include a microcontroller unit (MCU), a non-volatile storage communicatively coupled with the MCU that stores audio files for different types of audio functions, and a digital signal processing (DSP) module communicatively coupled with the MCU. The DSP module may process multiple types of audio functions simultaneously through a layered architecture that consolidates and prioritizes different audio streams including emergency calls, acoustic vehicle alerts, chimes, and infotainment.

### CROSS REFERENCE TO RELATED APPLICATION(S)

The present application claims the benefit of U.S. Provisional Application No. 63/652,601, entitled “ZONAL ARCHITECTURE AUDIO SYSTEM”, filed May 28, 2024, the entirety of which is incorporated herein for reference.

### INTRODUCTION

This application is directed to zonal architecture for functional and power distribution and more particularly, audio system thereof associated with an electric vehicle.

### SUMMARY

The disclosed subject matter provides for an audio system implemented in a zonal architecture. The disclosed audio system design may comply with vehicle safety requirements while consolidating hardware or software used to implement the audio system.

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates an exemplary overhead view of a vehicle with zonal power distribution as described herein.

FIG. 1B illustrates an exemplary side view of a vehicle with zonal power distribution as described herein.

FIG. 1C illustrates an exemplary block diagram of a system with zonal power distribution as described herein.

FIG. 2 is an exemplary schematic block diagram of an audio system.

FIG. 3 is an exemplary schematic block diagram of an audio system.

FIG. 4 is an exemplary schematic block diagram of an audio system.

FIG. 5 is an exemplary schematic block diagram of an audio system.

FIG. 6 illustrates an exemplary method associated with an audio system.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The disclosed subject matter provides for a zonal architecture for power distribution and circuit design thereof that allows for redundancy in power distribution and therefore may protect against the loss of one or more power buses or electronic control units (ECUs). The ECU functions of the zonal architecture may be based on geographic zone of a vehicle, such as front left, front right, or rear zone. In addition, there may be a consolidation of audio functions in one zonal controller, which may minimize the number of audio components and number of failure points for audio functions. The audio functions may be implemented using a layered architecture that may allow for ASIL rated redundancy and fault tolerance, while prioritizing safety (e.g., emergency) audio events.

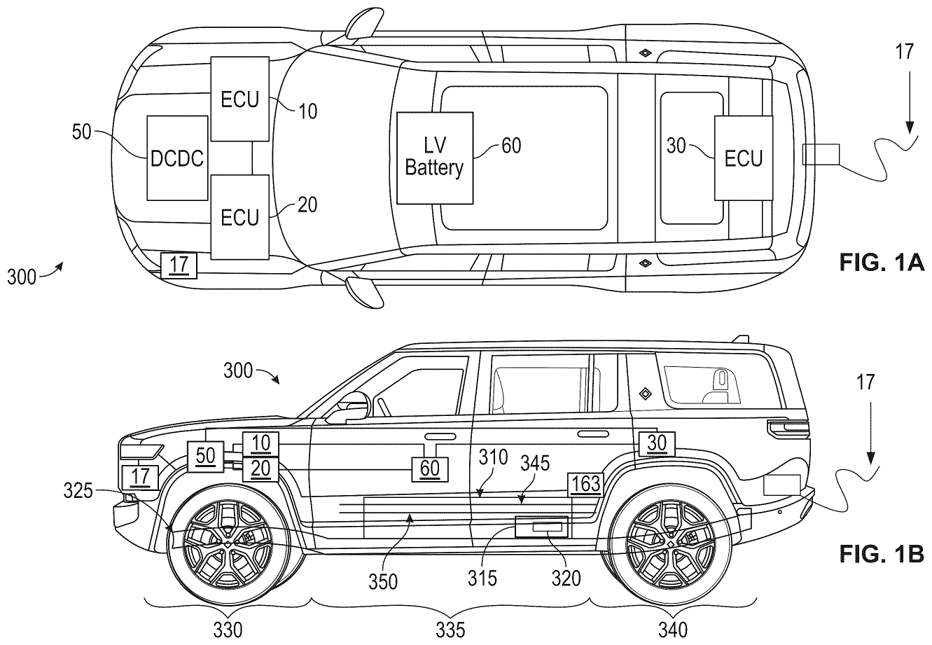

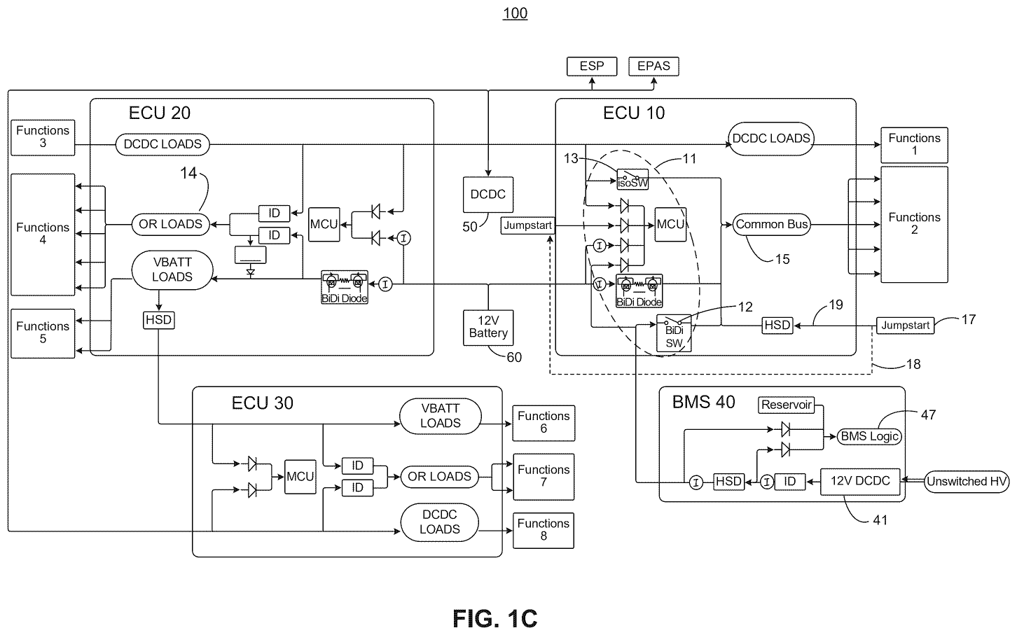

FIG. 1A illustrates an exemplary overhead view of vehicle 300. As further described herein, vehicle 300 may include electronic control units (ECUs) in front portion 330 of vehicle 300 (e.g., ECU 10 and ECU 20), an ECU in rear portion 340 of vehicle 300 (e.g., ECU 30), direct current to direct current converter (DCDC) 50, low voltage (LV) battery 60 (e.g., 12V battery), or jumpstart access 17, among other things.

FIG. 1B illustrates an exemplary side view of vehicle 300. As shown, the vehicle 300 may include one or more battery packs, such as high voltage (HV) battery pack 310 (e.g., 450V), which may be located near the center body portion 335 of vehicle 300. HV battery pack 310 may be coupled with one or more electrical systems of the vehicle 300 to provide power to the electrical systems. As further described herein, ECU 10, ECU 20, or ECU 30 may be communicatively connected with or have power distributed with each other and may be functionally redundant for power or other operations of electronic components of vehicle 300.

In one or more implementations, the vehicle 300 may be an electric vehicle having one or more electric motors that drive the wheels 302 of the vehicle using electric power from HV battery pack 310. In one or more implementations, the vehicle 300 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, the vehicle 300 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1B, the vehicle 300 may be implemented as a truck (e.g., a pickup truck) having a battery pack 310. As shown, HV battery pack 310 may include on or more battery modules 315, which may include one or more battery cells 320. However, this is merely illustrative and, in other implementations, HV battery pack 310 may be provided without any battery modules 315 (e.g., in a cell-to-pack configuration).

As shown in FIG. 1B, the vehicle 300 may include a support structure such as a chassis 325 (e.g., a frame, internal frame, or other support structure). The chassis 325 may support various components of the vehicle 300. As shown, the chassis 325 may span a front portion 330 (e.g., a hood or bonnet portion), center body portion 335, and a rear portion 340 (e.g., a trunk, payload, or boot portion) of the vehicle 300 in some implementations. In one or more implementations, HV battery pack 310 may be installed on the chassis 325 (e.g., within one or more of the front portion 330, center body portion 335, or the rear portion 340). As shown, HV battery pack 310 may include or be electrically coupled with one or more one busbars (e.g., one or more current collector elements). In the example of FIG. 1B, the vehicle 300 includes a first busbar 345 and a second busbar 350, either or both of which may include electrically conductive material to connect or otherwise electrically couple the battery module(s) 315 or the battery cell(s) s 320 with other electrical components of the vehicle 300 to provide electrical power to various systems or components of the vehicle 300.

In other implementations, the vehicle 300 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having a battery pack 310 (e.g., that powers the propulsion or drive components of the moveable apparatus).

FIG. 1C illustrates an exemplary block diagram of system 100 that may include a plurality of ECUs of vehicle 300. An ECU is an embedded system that may control one or more of the electrical systems or subsystems in a vehicle. The positioning and connections of ECU 10, ECU 20, or ECU 30 may provide for a level of redundancy for faults, which may be caused by collisions or other malfunctions. The design of system 100 may allow vehicle 300 to safely operate for a period after the fault, such as being able to drive vehicle 300 (e.g., steer, brake, or accelerate) to a safe position off of a roadway or being able to operate electronic controlled functions (e.g., door latches) of vehicle 300, among other things. As shown, ECU 10, ECU 20, and ECU 30 may be connected with DCDC 50 (also referred herein as DCDC bus 50) to operate DCDC loads and a low voltage (LV) battery 60 (e.g., 12V battery or LV battery bus 60) to operate LV battery loads. In an example, one or more ECUs (e.g., ECU 10) may include a fault isolation system 11. Fault isolation system 11 may include isolation switch or a bidirectional (Bidi) switch 12. In some configurations, in consideration of safety, only one ECU (e.g., ECU 10) may include fault isolation system 11. As shown, ECU 10 may include a common bus 15, which may operate slightly differently than other buses (e.g., OR load bus 14), as the common bus may allow for bidirectional power to be transmitted to and from LV battery 60 that may be a function of using fault isolation system 11. The common bus (specific to ECU 10) allows power to flow bidirectionally, from LV battery 60 to DCDC 50, or from DCDC 50 to LV battery 60. The OR bus does not allow power to flow bidirectionally (it does not connect or isolate LV battery 60 and DCDC 50 networks). The other element, which is a shared attribute of both common bus and OR Bus, that in the event of a failure of the DCDC 50 or LV battery 60, the common bus (or OR Bus) will retain operation (e.g., will be available).

With continued reference to FIG. 1C, each ECU may have on or more dedicated functions that may be powered by DCDC 50, LV battery 60, or LV DCDC 41. ECU 10 may operate functions 1, functions 2, and jumpstart functions. ECU 10 may be connected with jumpstart access 17 (e.g., wiring located in a rear portion 340 of vehicle 300). Jumpstart access 17 may allow an external power source (e.g., jumpstart pack) to connect with ECU 10 in order to jumpstart electronic functions of the vehicle, particularly when LV battery 60 is depleted. As further described herein, jumpstart access 17 may have multiple routes that include jumpstart route 18 (e.g., to microcontroller) and jumpstart route 19 (e.g., to Bidi switch 12). Functions 1 may include functions such as first row universal serial bus, or electronic stability program (ESP), among other things. Functions 2 may include functions such as right door latch, passenger seat motor, right headlamp, alarm module, in-vehicle infotainment (IVI), or frunk latch, among other things. In this example, functions 1 of ECU 10 may only be powered by DCDC 50, while functions 2 of ECU 10 may be powered by DCDC 50 (which may be the primary power) or LV battery 60 (which may be the secondary power), which may be referred to common bus 15. ECU 10 may be located on the right front of vehicle 300 and therefore may operate functions primarily for the right portion of vehicle 300.

As shown in FIG. 1C, ECU 20 may operate functions 3, functions 4, and functions 5. Functions 3 may include functions such as front suspension valves, or autonomy control module, among other things. Functions 4 may include functions such as steering angle sensor, front wiper motor, left door latches, left headlamp, exterior near field communication (NFC), or on-board diagnostics (OBD) port, among other things. Functions 5 may include functions such as electric power assisted steering (EPAS), charge port door, interior NFC, or electric powered assisted breaking, among other things. In this example, functions 3 of ECU 20 may only be powered by DCDC 50 and functions 5 of ECU 20 may only be powered by LV battery 60. Functions 4 of ECU 20 may be powered by DCDC 50 (which may be the primary power) or LV battery 60 (which may be the secondary power), which may be referred to OR loads 14 (also referred herein as OR load bus 14). ECU 20 may be located on the left front of vehicle 300 and therefore may operate functions primarily for the left portion of vehicle 300.

As shown in FIG. 1C, ECU 30 may operate functions 6, functions 7, and functions 8. Functions 6 may include functions such as license plate lamp. Functions 7 may include functions such as rear vehicle access system sensors, liftgate latch, trailer brake, right lamp rear, or left lamp rear, among other things. Functions 8 may include functions such as right trailer brake lamp, or rear suspension valves, among other things. In this example, functions 8 of ECU 30 may only be powered by DCDC 50 and functions 6 of ECU 30 may only be powered by LV battery 60. Functions 7 of ECU 20 may be powered by DCDC 50 (which may be the primary power) or LV battery 60 (which may be the secondary power). ECU 20 may be located on the left front of vehicle 300 and therefore may operate functions primarily for the left portion of vehicle 300.

System 100 of FIG. 1C may include a battery management system (BMS) 40. BMS 40 may be located at or near HV battery pack 310 of FIG. 1B, which LV DCDC 41 converts the HV DC to a lower voltage, such as 14V. LV DCDC 41 may help reduce the need for LV battery 60 for some operations, such as when vehicle 300 is in standby mode (e.g., parked). It is contemplated that the functions disclosed herein (e.g., functions 1 through functions 8) may be controlled by other ECUs or powered by any of the listed power sources.

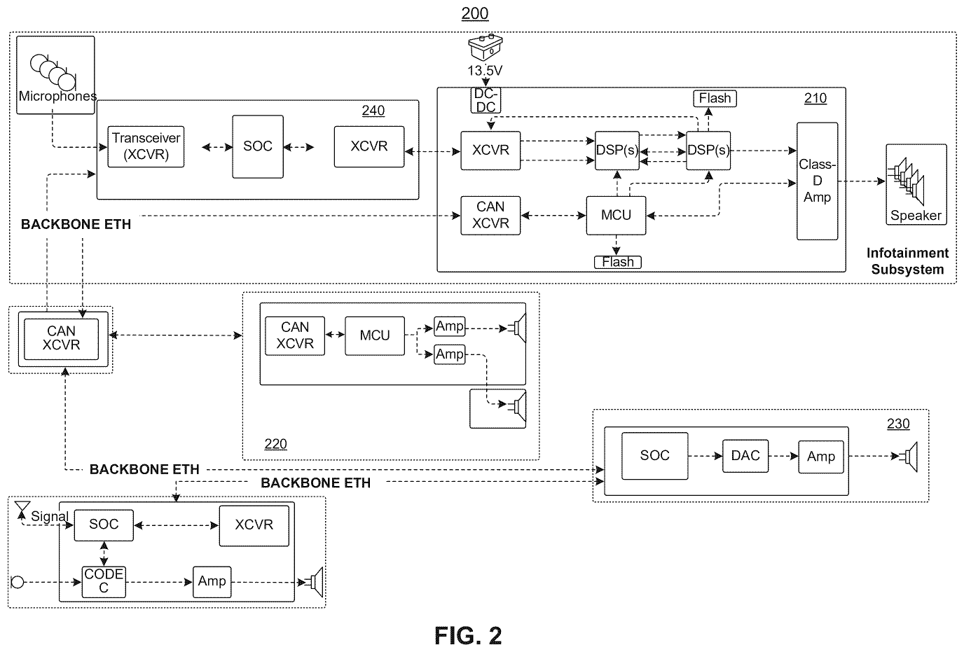

FIG. 2 illustrates an exemplary schematic block diagram of an audio system 200, which may be placed in a vehicle. As shown, audio system 200 may include multiple different modules for each type of audio processing, which may include module 210, module 220, module 230, or module 240. Each module may be located in a separate electronic control unit and have different functionality, such as infotainment for module 210, an acoustic vehicle alert system (AVAS) for module 220, chimes for module 230, or emergency calls for module 240. The AVAS may also include the horn. Module 210 may be an in-vehicle infotainment (IVI) system with multiple components dedicated to its operations, such as a microphone, a SOC, an automotive audio bus (A2B) transceiver, digital signal processing (DSP) function, flash memory (e.g., non-volatile storage), CAN transceiver (i.e., Controller Area Network (CAN bus)), micro controller unit, digital signal processing block, an amplifier (amp), or speaker. Module 220 may be an AVAS module with multiple components dedicated to its operations, such as a CAN transceiver, micro controller unit, an amplifier, or speaker. Module 230 may be a chime module that uses ethernet and has multiple components dedicated to its operations, such as a system on a chip, digital-to-analog converter (DAC), or an amplifier. Module 240 may be a telematics control module that uses ethernet and has multiple components dedicated to its operations, such as a system on a chip, A2B, a microphone, a coder/decoder (CODEC), an amplifier, or a speaker. As disclosed system 200 with its various modules may include multiple modules and components and therefore may include multiple points of failure.

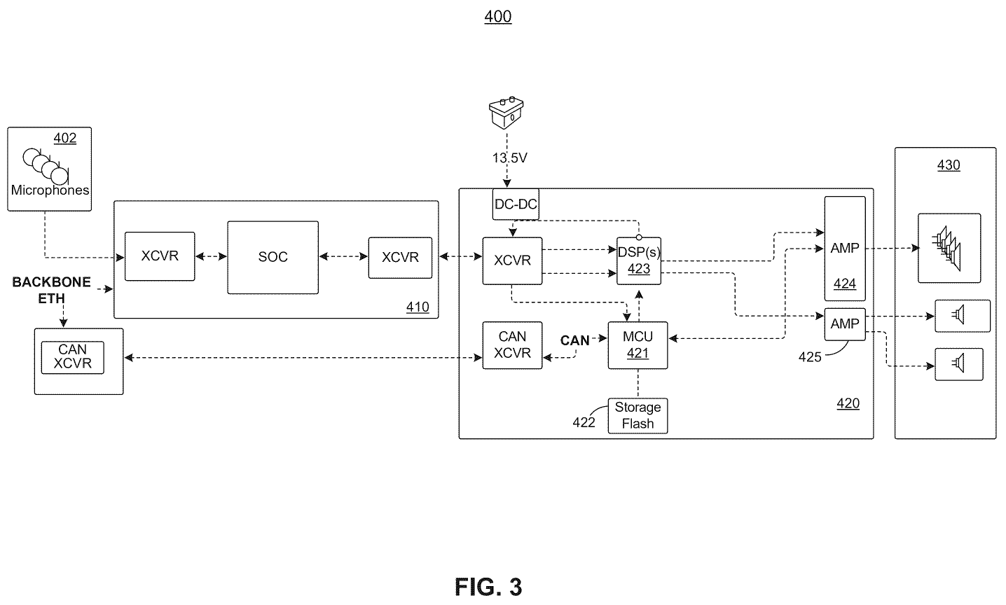

FIG. 3 illustrates an example schematic block diagram of an audio system 400. Some of the modules of FIG. 2 may be consolidated as shown in FIG. 3, which may reduce the number of components, reduce the points of failure, or reduce the cost, among other things. The zonal architecture disclosed herein may consolidate components and therefore may accommodate the design of system 400, in which system 400 may have one or more functions (e.g., functions 1 or functions 2 of FIG. 1C) operated using ECU 10 (as shown in FIG. 1A-FIG. 1C). System 400 may include microphone 402, module 410 (or audio input block 410), module 420, or audio output block 430. Module 410 may include components associated with audio input. Module 420 may include MCU 421, flash block 422, DSP block 423, amp block 424, or AVAS amp block 425, which may be communicatively connected with each other. MCU 421 may be connected with the one or more blocks of module 420. DSP block 423 may process various signals associated with audio functions, such as AVAS, chime, emergency calls, or infotainment, among other things. In DSP block 423, there is a security layer (e.g., with use of CRC) that may be used. Flash block 422 may be memory storage for the different audio functions, such as AVAS, chime, or infotainment, among other things. Flash block 422 may be logically separated with the different audio functions, may be physically different flash memories for each audio function, or an option of separate flash addresses. There may be one or more amplifiers for each audio function, such as amp block 424 or AVAS amp block 425.

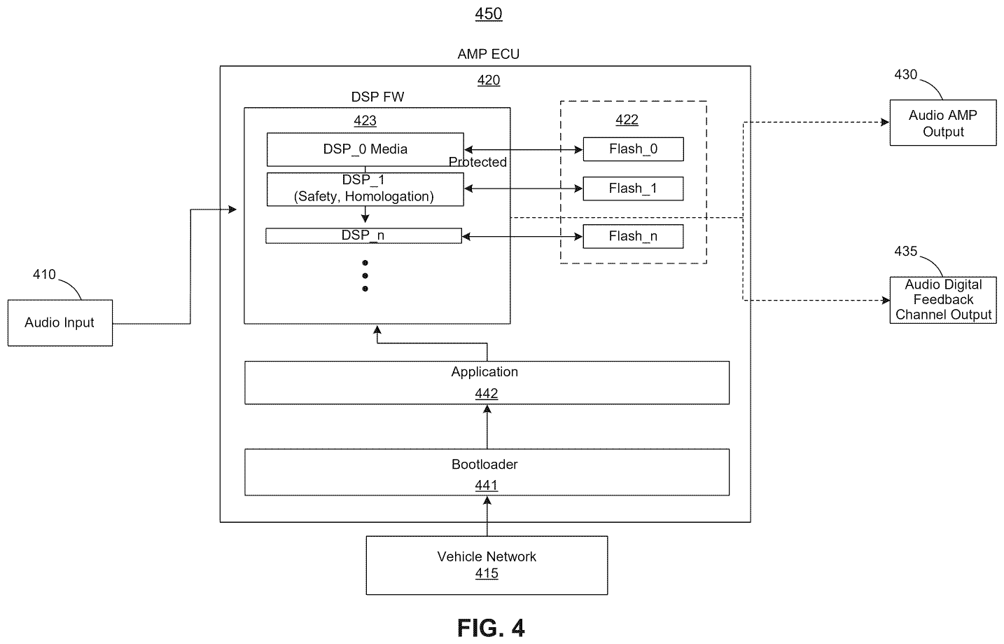

FIG. 4 illustrates an example schematic block diagram of an audio system 450. System 450 may be similar to system 400 but may emphasize different areas of module 420. As shown, module 420 may interface with audio input block 410, vehicle network 415, audio output block 430, or audio feedback block 435. Audio input block 410 may include input from a microphone 402. Vehicle network 415 may include CAN, ethernet, or other networks. Audio feedback block 435 may be associated with cancelling out feedback for speakers.

With continued reference to FIG. 4, module 420, as shown, may have a layered architecture for the audio functions. Bootloader layer 441 and application layer 442 may be a base layer that may be shared by all or some of the audio functions. As disclosed herein, DSP block 423 may function to process signals associated with different audio functions, which may be processed simultaneously and may share the different audio inputs 410, audio outputs 430, or vehicle network 415 (e.g., CAN transceivers). Audio functions, such as AVAS, chime, or infotainment may have different function blocks (e.g., partitioned) in DSP block 423 and may be configured to play using different channels.

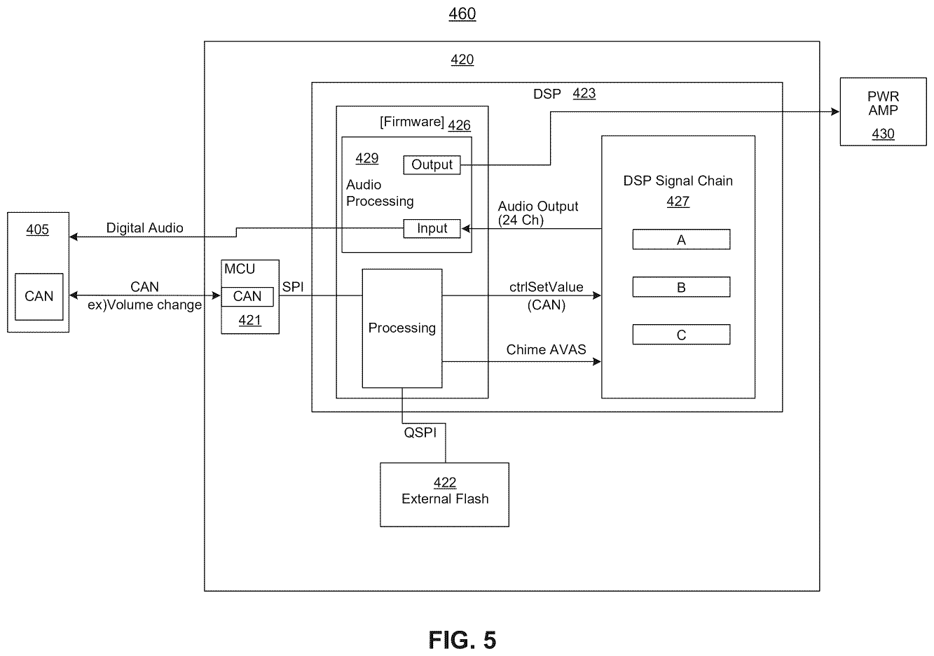

FIG. 5 illustrates an example schematic block diagram of an audio system flow based on the audio system architecture herein. In an example, there may be a volume change which is communicated to IVI 405. IVI 405 may send through vehicle network 415 (e.g., CAN transceivers) a message that indicates the volume change. MCU 421 may receive the message that indicates the volume change and send to DSP block 423. The firmware block 426 of DSP block 423 may determine the information to send to DSP signal chain 427, such as appropriate audio file that may be executed by flash driver to obtain from flash 422 and appropriate function (e.g., Control Value), which may be from a CAN manager. DSP signal chain 427 may be where the signal flow lives. DSP signal chain 427 may assist with weaving audio.

With continued reference to FIG. 5, DSP signal chain block 427 may process the received values from flash 422 and the CAN manager and based on such received values, send an audio output with the appropriate channels (e.g., 24 Channels) to audio processing block 429. The audio output may be fed back at audio processing block 429 in order to cancel acoustic feedback. Audio processing 429 may send audio output to a power amplifier (e.g., 4 each—16 channel). System 460 of FIG. 5 may be similar to system 400 or system 450 but may emphasize different areas of module 420.

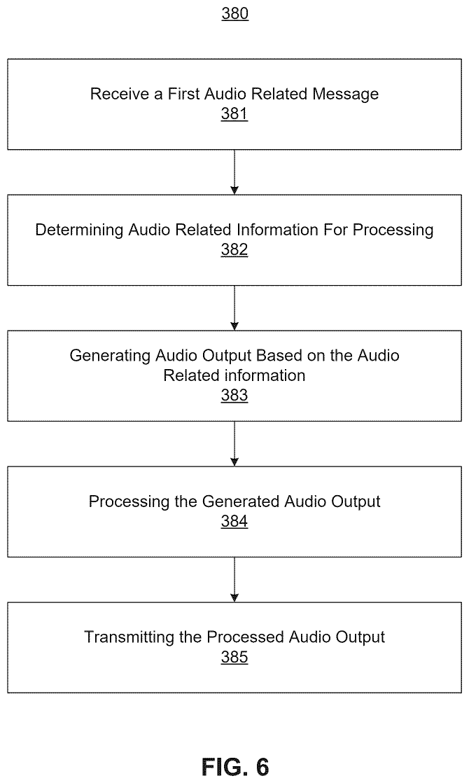

FIG. 6 illustrates an exemplary method 380 associated with an audio system. At step 381, a first message (e.g., an audio control message) associated with manipulation of audio may be received. The audio may be related to AVAS, chimes, safety, infotainment, or the like. The manipulation of the audio may include adjustment of volume level, adjustment of type of audio, instructions to direct audio to different speakers (e.g., surround sound), or the like. At step 382, based on the first message, determining audio related information (e.g., control or data information) to send. In an example, the audio related information may include CAN related control message (e.g., control values) or audio files (e.g., .wav or pulse-code modulation (PCM)). The audio related information may be sent to DSP signal chain 427. At step 383, based on the audio related information, generating audio output for audio processing block 429. At step 384, processing the audio output by audio processing block 429. At step 385, transmitting the audio output processed by audio processing block 429. The audio output may be transmitted to an audio amplifier or speaker. The audio output may be transmitted in coordination with a tactile queue. A tactile queue in a vehicle may include physical feedback that alerts an occupant through touch-based sensation. The tactile queue may communicate information through mechanical signals detectable by human touch. Examples of tactile queues may include vibration patterns through the steering wheel, pulsating movements of the driver or passenger seats, haptic feedback from control surfaces or touchscreens, oscillating motions through foot pedals, rhythmic vibrations through seatbelts, or localized vibrating elements in armrests or other vehicle interior contact points. The tactile queues work in coordination with audio alerts and visual warnings to form a comprehensive notification system. For example, a safety warning may trigger simultaneous feedback through steering wheel vibration, audible chimes, and dashboard display indicators. The tactile queues may communicate different types of information through variations in vibration intensity, duration, pattern, or location within the vehicle cabin. Tactile queues may provide an additional sensory channel for conveying vehicle status, warnings, or other information to occupants.

The disclosed approach may meet automotive safety integrity level (ASIL) that may require a combination of alerts that include a visual queue, an auditory queue, or a tactile queue, with less components than some other audio configurations. In addition, safety critical audio streams (e.g., chimes) and non-safety critical audio streams (e.g., in-vehicle infotainment) may be appropriately prioritized and directed to different audio outputs (e.g., rear speaker, middle speaker, left speaker, right speaker, or the like).

The disclosed blocks may be further sub-divided and may operate to execute on different functions that are supported by a particular ECU. For example, CAN transceivers may have a plurality of CAN operations that may include platform CAN, body front CAN, or access CAN (e.g., access CAN may connect to the vehicles access modules).

The methods, systems, or apparatuses disclosed herein may be incorporated into electric vehicles or other devices. The circuit blocks disclosed herein may be distributed with or combined with one or more ECUs or other devices. The methods, systems, or apparatuses disclosed herein may be incorporated into products, such as various feature specific or zone specific electronic control units (ECUs).

Methods, systems, and apparatuses for processing vehicle audio functions are disclosed herein. An apparatus may include a microcontroller unit (MCU); a non-volatile storage communicatively coupled with the MCU, wherein the non-volatile storage may include a plurality of audio files associated with audio of a vehicle for a plurality of types of audio functions; and a digital signal processing (DSP) module communicatively coupled with the MCU, wherein the DSP module may process the plurality of types of audio functions associated with the vehicle. The apparatus may include an electronic control unit of an electric vehicle. The plurality of types of audio functions may include audio associated with emergency calls, audio associated with acoustic vehicle alert system, audio associated with chimes, and audio associated with infotainment, or audio associated with emergency calls and audio associated with acoustic vehicle alert system. The DSP module may include a firmware block; a DSP signal chain block; and an audio processing block, wherein the firmware block receives control values from the microcontroller unit, and wherein the DSP signal chain block outputs audio signals through multiple channels. The plurality of types of audio functions may be partitioned into different functional blocks in the DSP module and share a bootloader layer and an application layer. The DSP signal chain block may transmit an audio output based on received values from the non-volatile memory and a controller area network manager. All combinations (including the removal or addition of steps) in this paragraph and the above paragraphs are contemplated in a manner that is consistent with the other portions of the detailed description.

Methods, systems, and apparatuses for processing audio in vehicles are disclosed herein. A system may include a microcontroller unit; a digital signal processing (DSP) block communicatively coupled with the microcontroller unit; a flash storage block communicatively coupled with the DSP block, wherein the flash storage block may include a plurality of partitions for storing different types of audio function data; and a plurality of amplifiers communicatively coupled with the DSP block, wherein the DSP block processes audio signals for concurrent output through the plurality of amplifiers based on the different types of audio function data. The different types of audio function data may include audio data for emergency calls; audio data for acoustic vehicle alert system (AVAS); audio data for chimes; or audio data for infotainment. The DSP block may include a firmware block; a DSP signal chain block; and an audio processing block, wherein the firmware block receives control values from the microcontroller unit and the DSP signal chain block outputs audio signals through multiple channels. The system further may include an audio input block communicatively coupled with the DSP block, wherein the audio input block may include a microphone. The system may include a bootloader layer and an application layer. All combinations (including the removal or addition of steps) in this paragraph and the above paragraphs are contemplated in a manner that is consistent with the other portions of the detailed description.

A method may include receiving an audio control message at a microcontroller unit; retrieving audio data from a flash storage based on the audio control message; processing the retrieved audio data through a digital signal processing (DSP) block; generating a multi-channel audio output signal based on the processed audio data; and routing the multi-channel audio output signal to a plurality of amplifiers for concurrent output. The audio data may correspond to audio for emergency calls, audio for acoustic vehicle alert system (AVAS), audio for chimes, or audio for infotainment. The method includes receiving audio input through a microphone and processing the audio input through the DSP block. Processing the retrieved audio data may include determining control values based on the audio control message; configuring a DSP signal chain based on the control values; and generating the multi-channel audio output signal through the configured DSP signal chain. The method provides feedback cancellation for the multi-channel audio output signal and routing the multi-channel audio output signal may include directing different type of audio to different amplifiers. All combinations (including the removal or addition of steps) in this paragraph and the above paragraphs are contemplated in a manner that is consistent with the other portions of the detailed description.

Methods, systems, or apparatuses for processing audio in vehicles may provide for receiving an audio message; determining audio information to retrieve based on the audio message; retrieving the determined audio information from partitioned storage; processing the retrieved audio information through a digital signal processor (DSP); and outputting processed audio signals through multiple amplifiers. The audio information may include audio data for emergency calls, audio data for acoustic vehicle alert system (AVAS), audio data for chimes, or audio data for infotainment. The operations further may include receiving audio input through a microphone and processing the received audio input through the DSP. Processing the retrieved audio information may include determining control values based on the audio message; configuring a DSP signal chain based on the control values; and generating the processed audio signals through the configured DSP signal chain. The operations further may include providing feedback cancellation for the processed audio signals and outputting the processed audio signals may include directing different type of audio to different amplifiers. All combinations (including the removal or addition of steps) in this paragraph and the above paragraphs are contemplated in a manner that is consistent with the other portions of the detailed description.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. In addition, the use of the word “or” is generally used inclusively unless otherwise provided herein. The methods herein may be implemented locally or remotely or in combinations of local and remote systems, configured to perform a function that can be implemented using software, hardware, or combinations thereof in the above-described environments.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus comprising:
microcontroller unit (MCU);
a non-volatile storage communicatively coupled with the MCU, wherein the non-volatile storage comprises a plurality of audio files associated with audio of a vehicle for a plurality of types of audio functions; and
a digital signal processing (DSP) module communicatively coupled with the MCU, wherein the DSP module processes the plurality of types of audio functions associated with the vehicle.

2. The apparatus of claim 1, wherein the apparatus comprises an electronic control unit of an electric vehicle.

3. The apparatus of claim 1, wherein the DSP module comprises:
a firmware block;
a DSP signal chain block; and
an audio processing block.

4. The apparatus of claim 3, wherein the firmware block receives control values from the microcontroller unit.

5. The apparatus of claim 3, wherein the DSP signal chain block outputs audio signals through multiple channels.

6. The apparatus of claim 1, wherein the plurality of types of audio functions are partitioned into different functional blocks in the DSP module.

7. The apparatus of claim 1, wherein the plurality of types of audio functions shares a bootloader layer and an application layer.

8. The apparatus of claim 1, wherein the DSP signal chain block sends an audio output based on received values from the non-volatile storage and a controller area network manager.

9. The apparatus of claim 1, wherein the plurality of types of audio functions comprises audio associated with emergency calls, audio associated with acoustic vehicle alert system, audio associated with chimes, and audio associated with infotainment.

10. The apparatus of claim 1, wherein the plurality of types of audio functions comprises audio associated with emergency calls and audio associated with acoustic vehicle alert system.

11. A method comprising:
receiving an audio related message;
determining, based on the audio related message, audio related information for processing;
generating audio output, based on the audio related information;
processing the generated audio output; and
transmitting the processed audio output.

12. The method of claim 11, wherein the audio related information comprises audio files associated with one or more types of audio functions or controller area network related control messages associated with the one or more types of audio functions.

13. The method of claim 12, wherein the one or more types of audio functions comprises audio for emergency calls, audio for acoustic vehicle alert system, audio for chimes, and audio for infotainment.

14. The method of claim 11, wherein the audio related information comprises an indication of an adjustment to volume level, an indication of an adjustment of type of audio, or an indication to direct audio to different speakers.

15. An electric vehicle comprising:
a processor; and
a memory coupled with the processor, the memory comprising executable instructions that when executed by the processor cause the processor to effectuate operations comprising:
receiving an audio message;
determining audio information to retrieve based on the audio message;
retrieving the audio information from a partitioned storage;
processing the audio information through a digital signal processor (DSP); and
outputting the processed audio information through multiple amplifiers.

16. The electric vehicle of claim 15, wherein processing the audio information comprises:
determining control values based on the audio message;
configuring a DSP signal chain based on the control values; and
generating the processed audio information through the configured DSP signal chain.

17. The electric vehicle of claim 15, wherein the audio information comprises:
audio data for emergency calls;
audio data for acoustic vehicle alert system;
audio data for chimes; or
audio data for infotainment.

18. The electric vehicle of claim 15, wherein the operations further comprise:
receiving audio input through at least one microphone; and
processing the received audio input through the DSP.

19. The electric vehicle of claim 15, wherein the operations further comprise providing feedback cancellation for the processed audio information.

20. The electric vehicle of claim 15, wherein outputting the processed audio information comprises directing different types of audio to different amplifiers.
